(19) United States
(12) Patent Application Publication
(10) Pub. No.: US 2025/0178448 A1
(43) Pub. Date: Jun. 5, 2025

(54) PENDULUM POWER TRANSMISSION DRIVE WHEEL WITH MECHANICAL RECOVERY OF PART OF THE BRAKING ENERGY

(71) Applicant: Manuel Lahuerta Romeo, Las Lomas del Galleg (ES)

(72) Inventor: Manuel Lahuerta Romeo, Las Lomas del Galleg (ES)

(21) Appl. No.: 18/285,230

(22) PCT Filed: Jan. 27, 2022
(86) PCT No.: PCT/ES2022/070036

§ 371 Date: Feb. 19, 2025

(30) Foreign Application Priority Data
Feb. 2, 2021 (ES) P202130086

(51) Int. Cl. B60L 7/24; B60K 7/00; B60K 17/04; B60L 50/30

(52) U.S. Cl. CPC B60L 7/24; B60K 7/0007; B60K 17/046; B60L 50/30; B60K 2007/0061

(57) ABSTRACT

Pendulum power transmission drive wheel with mechanical recovery of part of the braking energy, developed from a reducer (3) attached to the vehicle suspension. The drive wheel (1) is fixed to the slow shaft (4) of the reducer (3). On the fast shaft (5) on its stub axle, a bearing (7) is fixed from which a swing arm (6) hangs, at the end of which the engine (8) is fixed, which drives the fast shaft (5) by means of a belt transmission (11), chain or gears, forming a pendulum assembly (19). On the arm (6) brake calipers (14) are mounted which, when activated on the disc (13), keep the pendulum assembly (19) raised, by the effect of the engine brake (8), accumulating potential energy. To move the vehicle, the calipers (14) are deactivated and the engine (8) is started simultaneously, recovering part of the braking energy on its descent and facilitating the starting of the engine (8) and the vehicle.

### OBJECT OF THE INVENTION

The invention, as expressed in its statement, relates to a pendulum power transmission drive wheel with mechanical recovery of part of the braking energy, driven by a pendulum power transmission, capable of mechanically storing and restoring the braking energy through a pendulum mechanism, which then allows it to start the vehicle smoothly, requiring less starting torque from the engine. This means the use of smaller engines with less energy consumption and, therefore, less pollutants. The technical goal of the present design is to ensure that the driving force reaches the wheel by the shortest path and in the smoothest way.

Vehicles equipped with this technology will be suitable for use on circuits with frequent stops and starts, as is the case with city buses.

The aim is to achieve vehicles for urban transport that need less power to accelerate and, due to their lightness, exert less specific pressure on the pavement, providing more driving comfort for passengers and resulting in cleaner and quieter cities.

### FIELD OF APPLICATION

The field of application of the present patent is in the field of design, construction and use of vehicles for urban transport.

### BACKGROUND OF THE INVENTION

The electric vehicle represents the future of urban transport. Almost all manufacturers adapt more or less original solutions by offering a wide range of electric-only or hybrid vehicles, which help to alleviate the problem of pollution generated by city transport.

Usually, city buses have an engine, clutch, gearbox, transmission and differential, with the sole purpose of bringing power to the shaft of the drive wheels that, in contact with the ground, move the vehicle.

Achieving buses with less inertia, which are capable of starting with low engine torques due to having additional potential energy in the pendulum, based on less overloaded structures (chassis), is the philosophy of the design of the present invention, constituting in itself a novelty within the field of application, and it should be noted that the applicant is not aware of any other invention with similar technical and configuration characteristics.

### DESCRIPTION OF THE INVENTION

Usually, city buses have an engine, clutch, gearbox, transmission and differential, with the sole purpose of bringing power to the shaft of the drive wheels that, in contact with the ground, move the vehicle.

The technical goal of the patent application is to ensure that the power reaches the wheel by the shortest path and in the smoothest way. The present design places all power transmission components directly on the drive wheel shaft and not on the chassis.

City buses are vehicles that are constantly starting and stopping, achieving an average speed of about 12 km/h.

Hence, for frequent starting and stopping, the power is mainly spent on accelerating the mass of the bus.

It is therefore necessary to have the weight where it contributes to traction, that is, at the drive wheels, and it is desirable to reduce the overall weight in order to minimise inertia, and thus power and fuel consumption.

In the present invention, the engine and transmission weights are located on the drive wheel shaft, contributing to improved traction even when the vehicle is empty.

On the other hand, as it does not need to support the torques due to the engine and the transmission, the chassis can be lighter.

Currently, an empty city bus weighs about 13 mt, to transport 50 people of 75 kg, that is 3.75 mt, with a Tare/Load ratio=3.33

With the present patent, a tare of 5 mt could be achieved for transporting the same 50 people, that is, a Tare/Load ratio=1.33

Another way of transmitting power to the wheel shaft in a progressive manner is to use a swinging pendulum acting as a lever arm to transmit the torque to the drive wheel; this is part of the present innovation.

If the rotation axis of the pendulum is concentric to the fast shaft of the epicyclic reducer, the input torque caused by the pendulum will become a greater torque on the output shaft of the reducer, where the wheel is located, transmitting it to the wheel.

An engine delivers its mechanical power with a low torque at high revolutions; on the other hand, the drive wheel needs a high torque at low revolutions, hence the best link between the two is an epicyclic reducer which is designed with its shafts coaxially arranged. Therefore, this arrangement is the most suitable for this implementation, as demonstrated in the present patent application.

On the other hand, the pendulum is the most sensitive mechanism, as it can oscillate with small forces that unbalance it, hence it is an ideal mechanism to locate the engine so that a lower torque is required when starting it.

As the pendulum rises, the reaction torque increases, progressively delivering it through the epicyclic reducer, to the wheel, until said pendulum torque overcomes the reaction torque of the wheel and the vehicle starts. In the braking process, the engine will act as a generator and the pendulum will rise in the opposite direction to the direction of travel.

In turn, the pendulum allows potential energy to be converted into kinetic energy when descending and vice versa. It is therefore a suitable mechanism for mechanically storing braking energy as it rises as a result of the reaction torque exerted by the engine brake and maintains this position by means of the brake calipers located on the pendulum swing arm.

The driver will keep the brake activated (pendulum raised) while the bus is stopped, deactivating it to start, which will cause the pendulum to descend in the direction of travel, delivering its potential energy to the wheel, thus recovering a good part of the braking energy.

The mechanism described perfectly solves the problem of vehicles with frequent starts and stops, which travel at moderate speeds.

Thus, the new pendulum power transmission drive wheel represents an innovative solution with characteristics and operations unknown until now for this purpose, reasons that, together with its practical utility, provide the present patent application with the basis for obtaining the privilege of exclusivity that is requested.

### DESCRIPTION OF THE DRAWINGS

In order to complement the description being made and in order to assist in a better understanding of the features of the invention, a set of drawings is attached to this specification, as an integral part thereof, in which the following is illustrated for illustrative and non-limiting purposes:

FIG. 1.-Shows an elevational view and profile of a drive wheel coupled to the suspension of a vehicle, as an example of a preferred embodiment, showing the main elements that compose it, marked and described as follows:
1) Wheel with its rim and disc.
2) Wheel hub integral with the reducer slow shaft.
3) Epicyclic reducer with its coaxial shafts (slow and fast).
4) Reducer slow shaft.
5) Reducer fast shaft, where the pendulum transmission engages.
6) Pendulum swing arm.
7) Bearing from which the pendulum swing arm hangs.
8) Engine located at the end of the pendulum swing arm.
9) Coupling with electromagnetic clutch, which releases the sprocket (10).
10) Sprocket.
11) Transmission toothed belt.
12) Counterweight of the pendulum swing arm.
13) Brake disc, integral with the reducer housing (3)
14) Brake caliper integral with the pendulum swing arm (6)
15) Housing support of the reducer that attaches it to the suspension.
16) Articulated suspension arm or fork.
17) Suspension damper.
18) Elastic stops for angular displacement of the arm.
19) Pendulum assembly (6+8+9+10+11+12)

FIG. 2.-Shows an example of application of the drive wheel propelling a three-wheeled bus.

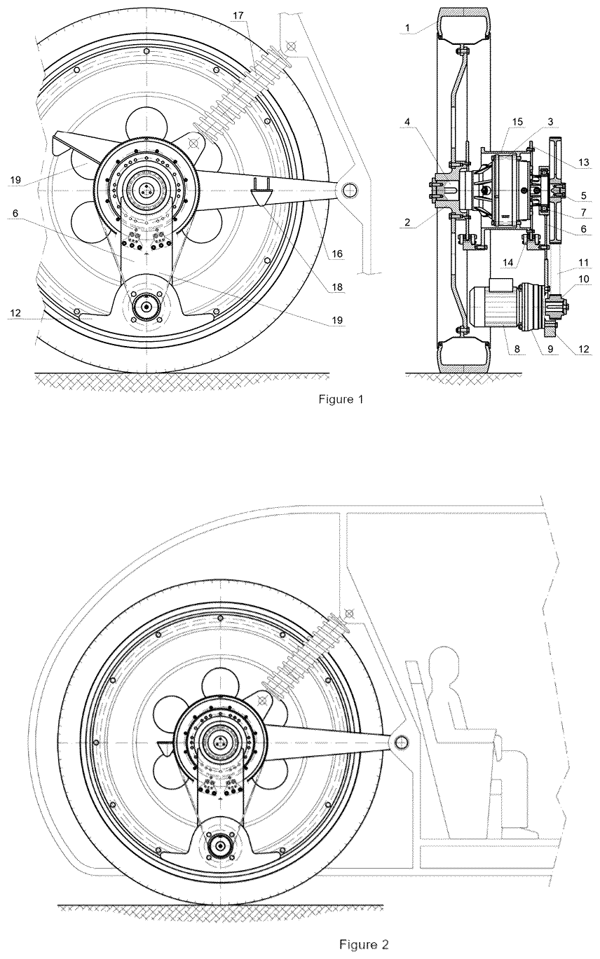

### PREFERRED EMBODIMENT OF THE INVENTION

Following the numbering reflected in the figures, a preferred embodiment of the invention will be dimensioned, to be applied to a city bus with the following requirements:

| Maximum speed | 55 | km/h |
|---|---|---|
| Maximum slope to overcome | 6% | |
| Acceleration 0-30 km/h | ≤8 | seconds (s) |
| Vehicle weight without load | 5,000 | kg |
| Max. number of passengers | 50 | |
| Max. weight in motion | 8,800 | kg |
| Number of drive wheels | one | |
| Drive wheel diameter | 2 | m |

From these requirements, the power and torque to be applied to the shaft (4) of the wheel (1) to overcome a 6% slope equivalent to an angle of □=3.43° will be calculated.

Force to be applied on the periphery of the wheel:
Fp=M×g×sin=5, 165 N that applied on a radius R=1 m means having on the shaft (4) a torque of 5,165 Nm

Max. torque to be applied to the wheel shaft (4) to overcome the slope 5,165 Nm To roll at 55 km/h=15.28 m/s the wheel would have to rotate at:

$$15.28 \times 60 / \times 2 = 145.9 rpm$$

To maintain this speed on flat ground, the rolling and aerodynamic forces must be overcome, which are calculated from the respective coefficients: Kr=0.006 Kd=0.6, with the projected area in the direction of travel being 2.5×3=7.5 m²
Rolling forces Fr=M×g×Kr

$$Fr = 8 , 800 \times 9.81 \times 0.006 = 518 N$$

Aerodynamic forces Fa=½(area×dₐᵢᵣ×V²×Kd)

$$1 / 2 ( 7.5 \times 1.23 \times {15.28}^{2} \times 0.6 ) = 646 N$$

Therefore, the power required to travel on flat ground at 55 km/h will be:

$$kW = ( Fr + Fa ) Vm / 1000 = ( 518 + 646 ) \times 15.28 / 1000 = 17.8 kW$$

Taking into account performance losses in power transmission:

| | |
|---|---|
| Epicyclic reducer performance (3) | 96% |
| Pendulum transmission performance (6) | 97% |
| Total performance = 0.96 × 0.97 = | 0.93 |

Therefore, the power to be delivered by the engine will be kW=17.8/0.93%=19.14 KW

$$Required engine power ( 8 ) to travel at 55 km / h = 19.14 kW$$

To accelerate from 0 to 30 km/h=8.33 m/s in 8 seconds, the vehicle must be supplied with energy of:

$$E = 1 / 2 m \times {V}^{2} = 1 / 2 \times 8 , 800 \times {8.33}^{2} = 305 , 311 Joules$$

Requiring a power to accelerate the vehicle in 8 seconds of:

$$kW = 305 , 311 / 8 \times 1 , 000 = 3 8.16 kW$$

To this power must be added the power required to overcome the rolling and aerodynamic resistances at this speed (8.33 m/s) as follows:

$${kW}_{rollng} = Kr \times 8 , 800 \times {8.33}^{2} = 3 , 664 W = 3.66 kW$$

$${kW}_{aerodynamic} = 1 / 2 ( 7.5 \times 1.23 \times {8.33}^{2} \times 0.6 ) = 192 W = 0.19 kW$$

Therefore, the power required to accelerate the vehicle to 30 km/h in 8 seconds will be the sum of the three powers:

$$kW = 38.16 + 3.66 + 0.19 = 4 2.01 kW$$

Power to accelerate from 0-30 km/h in 8 seconds=42.01 kW

Once the maximum torque requirements on the shaft (4) of the wheel (1) to overcome the 6% slope and the maximum power are determined, the most suitable pendulum transmission and engine (8) shall be dimensioned, bearing in mind that the torque must be compensated by the torque of the pendulum assembly (19) in the 90° position.

Analysing the engine market, an engine capable of delivering at least 42 KW at 3,600 rpm, capable of delivering a constant torque at the shaft (4) of the wheel (1) of 5,165 Nm sufficient to overcome a 6% slope, will be sought.

The total transmission ratio between engine (8) and wheel (1) will be:

$$i = 3 \; 600 / 14 \; 5.9 = 24.67$$

This total transmission ratio (24.67) shall be distributed between the reducer (3) and the pendulum transmission (19) as appropriate.

Therefore, the torque demanded from the sprocket (10) of the transmission, taking into account an overall performance of 0.93, will be:

$$5 , 165 / 24.67 \times 0.93 = 225 Nm$$

Therefore, the engine (8) will require a mechanical power on its shaft, capable of providing a torque of 225 Nm at 3600 rpm, so its power will be at least:

$$kW = 225 \times 3600 / 9.55 = 84.8 kW$$

This power will improve the acceleration phase performance of the vehicle by accelerating it in: 305,311/(85−(3.66−0.2))×1000=3.76 seconds.

This torque on the sprocket (10) of 225 Nm must be compensated by the moment generated by the angular displacement of the pendulum assembly (19), up to the horizontal. As it has a pendulum arm (6) of 0.7 m, the weight of the pendulum assembly (19) shall be at least 225/0.7=321 kg. In this way, in order to overcome a 6% slope, the pendulum assembly (19) will be raised to the horizontal, compensating with its weight the torque transmitted by the sprocket (10).

Selecting a synchronous permanent magnet engine (8) of 85 KW, LSRPM 200 L1 model, which with a nominal consumption of 158 A at 400 V, is capable of delivering a constant torque of 225 Nm at 3,600 rpm, with a weight of 168 kg. It will be necessary to supplement with additional counterweights (12) up to the 321 kg required to balance the torque with the pendulum assembly (19).

Thus, the pendulum assembly (19) will compensate with its angular displacement up to 90°, the torque provided to the fast shaft (5), in order to achieve through the reducer (3) increase the torque on the shaft (4) that drives the wheel (1).

When it comes to recovering the braking energy, the pendulum assembly (19) will be raised, in the opposite direction to the direction of travel, when the engine (8) acts as a generator, describing an angle of up to 120°, raising the pendulum assembly (19) up to 1 m in height and retaining it, in that position, by activating the brake calipers (14) on the fixed disc (13), accumulating:

$$M \times g \times h = 321 \times 98.1 \times 1 = 3 , 150 Joules .$$

Energy which, by simultaneously deactivating the brake and starting, will be added to that of the engine (8) to facilitate starting the vehicle.

This is an important aid to the engine (8) in the starting phase, which comes from a mechanical accumulation of a part of the braking energy.

Having sufficiently described the nature of the present invention, as well as the way of putting it into practice, it is not considered necessary to explain it further so that any person skilled in the art may understand its scope and the advantages deriving therefrom, it being noted that, within its essentiality, it may be put into practice in other embodiments which differ in detail from that indicated by way of example, to which the protection claimed will also apply provided that its fundamental principle is not altered, changed or modified.

1. Pendulum power transmission drive wheel with mechanical recovery of part of the braking energy, characterised in that it is developed from an epicyclic reducer, whose housing is fixed to the suspension of the vehicle to be moved, where on the side of the slow shaft of the reducer, the wheel is fixed with its parking brake, where on the side of the fast shaft, embedded in its stub axle a bearing is mounted, from which an swing arm hangs, at the end of which the engine is fixed, which drives the fast shaft by means of a belt transmission, chain or gearbox, forming a pendulum assembly, and where on the same arm brake calipers are mounted which, when activated, keep the pendulum assembly raised by the effect of the engine brake, recovering part of the braking energy in its descent that is added to that of the engine to start the vehicle.

2. Pendulum power transmission drive wheel with mechanical recovery of part of the braking energy, in accordance with all of claim 1, characterised in that it is dimensioned in such a way that the reaction torque caused by the pendulum assembly in its angular displacement balances the torque transmitted by the sprocket, compensating and balancing it.
